(19) United States
(12) Patent Application Publication
(10) Pub. No.: US 2007/0051579 A1
(43) Pub. Date: Mar. 8, 2007

(54) Differential unit structure

(76) Inventor: Bor-Yih Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/218,544

(22) Filed: Sep. 6, 2005

(51) Int. Cl. F16D 13/52

(52) U.S. Cl. 192/70.27; 192/89.27

(57) ABSTRACT

A differential unit structure includes a transmission shaft having a connecting tube. The connecting tube comprises a chamber to accommodate first friction plates for a driven shaft to insert therein. The driven shaft has a connecting rod engaging with second friction plates. An engaging seat is to urge the first friction plates and the second friction plates to mesh with each other tightly to link the transmission shaft and the driven shaft starts to spin. When the engaging seat is pushed by an activating rod to move, the first friction plates and the second friction plates are separated to form a differential speed.

### BACKGROUND OF THE INVENTION

1. Field of the Invention

The present invention relates to a differential unit structure, in particular to one that utilizes engagement and disengagement of first friction plates and second friction plates of a transmission shaft and a driven shaft to form a differential speed.

2. Description of the Prior Art

A conventional electric mobility scooter is provided with an electric power to drive wheels. However, this scooter does not have a differential speed. When the rider makes a turn, he needs to make a wide turn, otherwise the scooter may be overturned.

In view of this and many other shortcomings, the inventor has derived the present invention to solve the problems.

### SUMMARY OF THE INVENTION

The primary object of the present invention is to provide a differential unit structure comprising a transmission shaft having a connecting tube. The connecting tube comprises a chamber. The inner wall of the chamber is provided with a plurality of troughs for engagement of first friction plates. Each of the first friction plates comprises a shaft aperture and a plurality of blocks around its circumferential edge for meshing with the troughs of the transmission shaft. A driven shaft is connected to the connecting tube of the transmission shaft and comprises a connecting rod provided with blocks thereon. Second friction plates are provided on the connecting rod of the driven shaft and engage with the first friction plates. Each of the second friction plates comprises a shaft aperture with a plurality of troughs around an inner edge for meshing with the blocks of the driven shaft. An engaging seat is provided on the driven shaft and urged by an elastic member to urge the first friction plates and the second friction plates. An activating rod penetrates through the connecting tube of the transmission shaft and comprises a push block to move the engaging seat.

It is another object of the present invention to provide a differential unit structure, which is safe for a rider.

It is a further object of the present invention to provide a differential unit structure, which is easy to operate.

### BRIEF DESCRIPTION OF THE DRAWINGS

FIG. 1 is a side cross sectional view of the present invention;

FIG. 2 is a cross-sectional view showing that first friction plates and second friction plates of the present invention are engaged together;

FIG. 3 is a cross-sectional view showing the assembly of the first friction plates and a transmission shaft;

FIG. 4 is a cross-sectional view showing the assembly of the second friction plates and a driven shaft;

FIG. 5 is a top enlarged view showing an activating rod of the present invention;

FIG. 6 is a top enlarged view showing a spinning block of the present invention in an operated status; and

FIG. 7 is a cross-sectional view showing that the first friction plates and the second friction plates of the present invention are separated.

### DETAILED DESCRIPTION OF THE PREFERRED EMBODIMENT

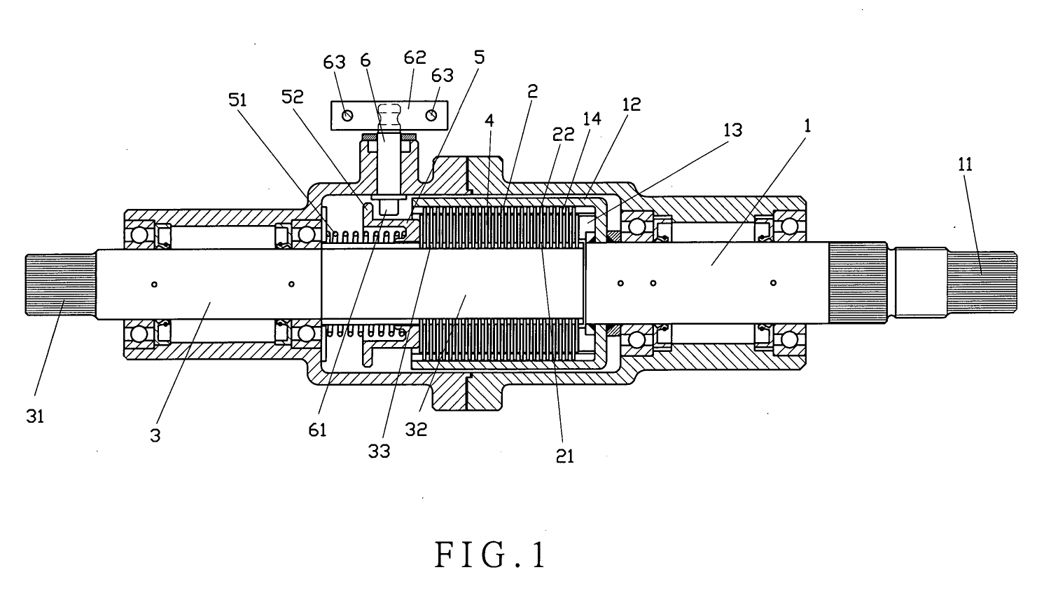

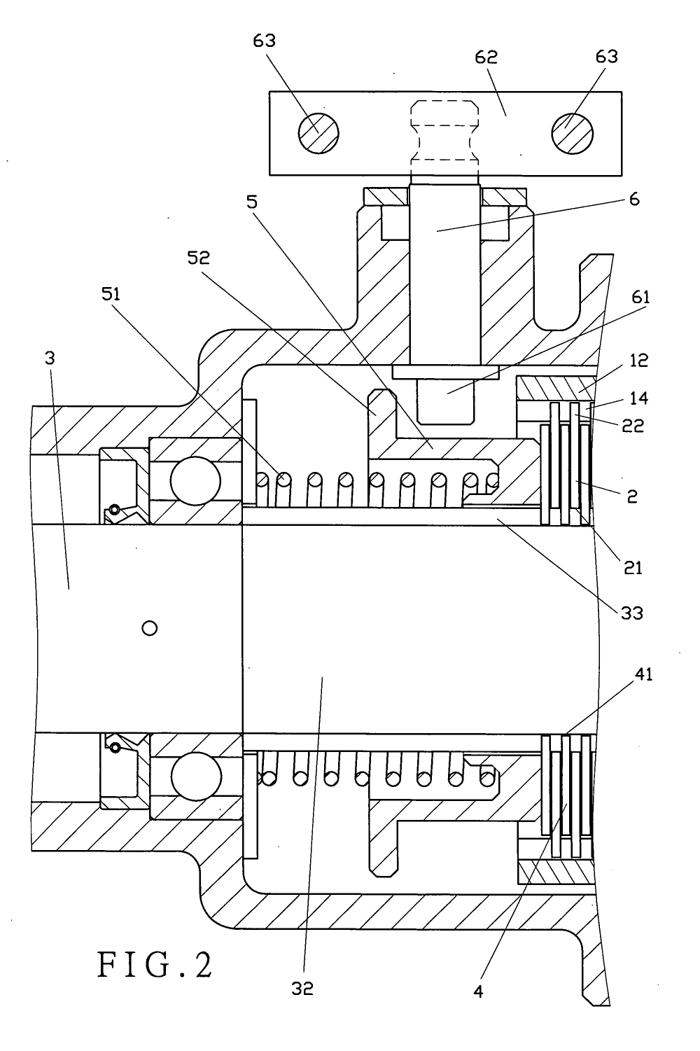

As shown in FIGS. 1 and 2, the present invention comprises a transmission shaft 1, first friction plates 2, a driven shaft 3, second friction plates 4, an engaging seat 5 and an activating rod 6.

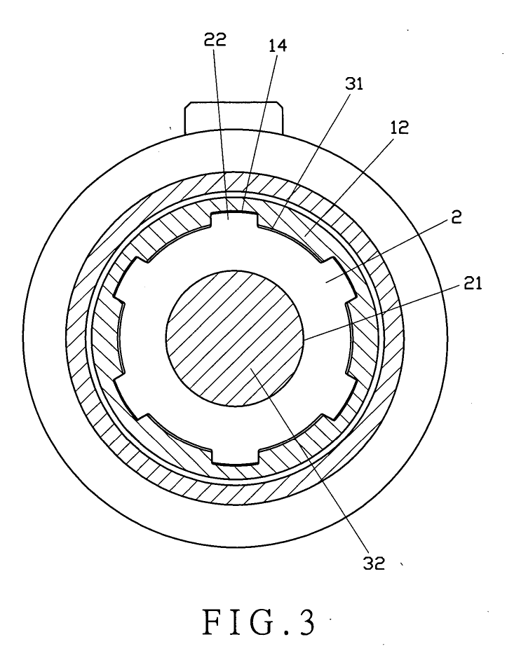

The transmission shaft 1 is connected to a power supply, and comprises a fixed end 11 and a connecting tube 12 at the other end. The connecting tube 12 comprises a chamber 13 with a plurality of troughs 14 on the inner wall of the chamber 13, as shown in FIG. 3.

The second friction plates 2 are deposited in the chamber 13 of the transmission shaft 1. Each second friction plate comprises a shaft aperture 21 and a plurality of blocks 22 around its circumferential edge to mesh with the troughs 14 of the transmission shaft 1.

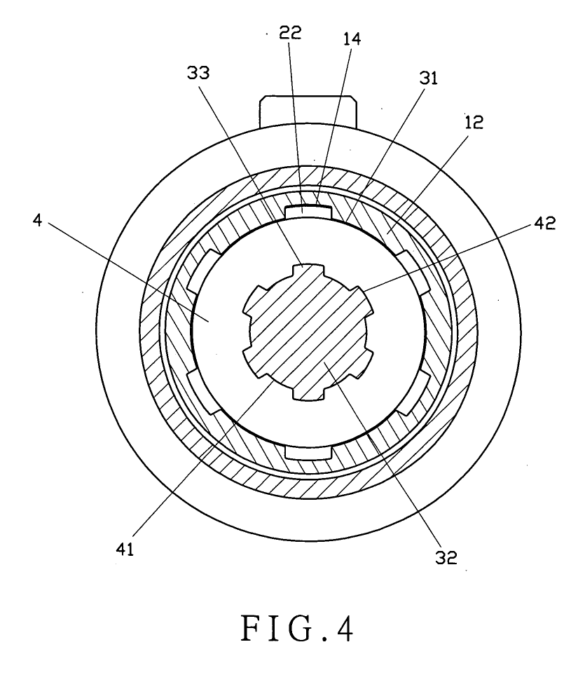

The driven shaft 3 is connected to the connecting tube 11 of the transmission shaft 1 and is activated by the transmission shaft 1. One end of the driven shaft 3 is a fixed end 31 and the other end is provided with a connecting rod 32 inserting through the shaft aperture 21 of the first friction plate 2. The connecting rod 32 is provided with a plurality of blocks 33 thereon, as shown in FIG. 4.

The second friction plates 4 are provided on the connecting rod 32 of the driven shaft 3. The first friction plates and the second friction plates are alternatively arranged and abutted to one another. Each second friction plate 4 has a shaft aperture 41. The inner wall of the shaft aperture 41 is provided with a plurality of troughs 42 for engagement of the blocks 33 of the driven shaft 3.

The engaging seat 5 is deposited on the driven shaft 3, and comprises an elastic member 51 to urge the first friction plates 2 and the second friction plates 4 together. The engaging seat 5 further comprises a flange 52 extending from one end thereof.

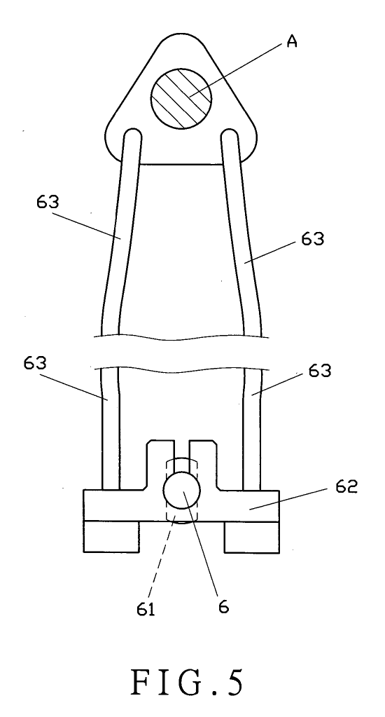

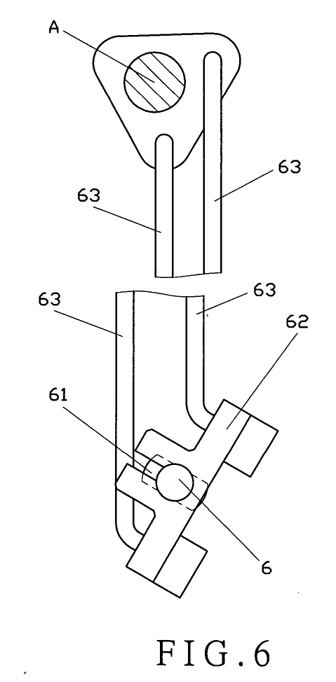

As shown in FIG. 5, the activating rod 6 penetrating through the connecting tube 12 of the transmission shaft 1 comprises a push block 61 at one end to move the engaging seat 5. The other end of the activating rod 6 is provided with a spinning block 62 to link the activating rod 6 to spin. The spinning block 62 is provided with cables 63 at respective sides for connection of a handle A of an electric mobility scooter, as shown in FIG. 6.

To operate the present invention, as shown in FIGS. 1 and 2, the fixed ends 11 and 12 of the transmission shaft 1 and the driven shaft 3 are provided with wheels (not shown in the drawings), and are driven by the transmission shaft 1 which is powered by the power supply. When the transmission shaft 1 is activated, the first friction plates 2 meshing with the troughs 14 in the chamber 13 will be urged by the engaging seat 5 towards the second friction plates 4 to link the second friction plates 4 to spin simultaneously. The driven shaft 3 is linked to spin simultaneously with the blocks 33 meshing with the second friction plates 4. Thus the wheels provided on the transmission shaft 1 and the driven shaft 3 are linked to move forward.

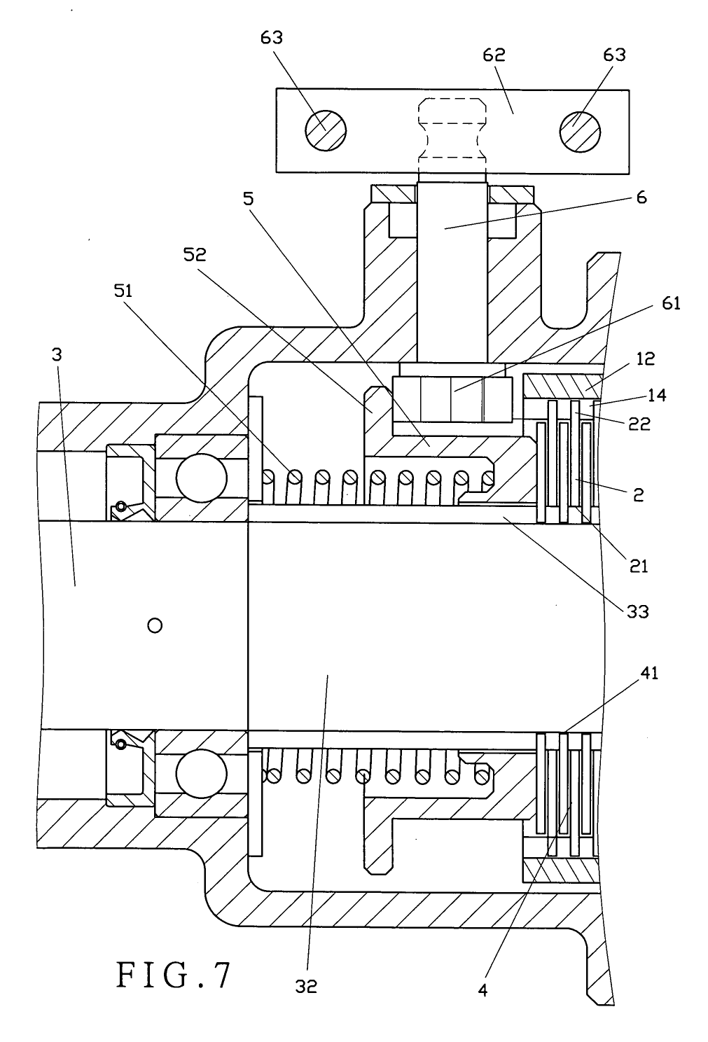

To make a left turn of the electric mobility scooter incorporated with the present invention, the handle A is turned to the left, as shown in FIG. 6, the spinning block 62 will be pulled by the cable 63, which then pulls the spinning block 62 and the activating rod 6 to spin. The flange 52 of the engaging seat 5 is pushed to urge the elastic member 51 to release the first friction plates 2 from the second friction plates 4, as shown in FIG. 7, thus the transmission shaft 1 can't link the driven shaft 3 to spin, and the speed is reduced. The left turn can be done smoothly. When making a right turn, the function of the mechanism of this invention is identical to the left turn. However, due to the right turn requires a larger radius, the driven shaft 3 requires a larger speed than the transmission shaft 1 in order to make a smooth right turn.

I claim:

1. A differential unit structure comprising a transmission shaft and a driven shaft, said transmission shaft being connected to a power source, said driven shaft being activated by said transmission shaft, and characterized in that the differential unit structure further comprises first friction plates, second friction plates, an engaging seat and an activating rod;
said transmission shaft comprising a connecting tube, said connecting tube comprising a chamber, an inner wall of said chamber being provided with a plurality of troughs;
said first friction plates being deposited in said chamber of said transmission shaft, each of said first friction plates comprising a shaft aperture and a plurality of blocks around its circumferential edge for meshing with said troughs of said transmission shaft;
said driven shaft being connected to said connecting tube of said transmission shaft and comprising a connecting rod provided with blocks thereon;
said second friction plates being deposited on said connecting rod of said driven shaft and engaging with said first friction plates, each of said second friction plates comprising a shaft aperture with a plurality of troughs around an inner edge for meshing with said blocks of said driven shaft;
said engaging seat being deposited on said driven shaft and urged by an elastic member to urge said first friction plates and said second friction plates;
said activating rod penetrating through said connecting tube of said transmission shaft and comprising a push block to move said engaging seat.

2. The differential unit structure, as recited in claim 1, wherein said first friction plates and said second friction plates are alternatively arranged and abutted to one another.

3. The differential unit structure, as recited in claim 1, wherein said activating rod comprises a spinning block to link said activating rod to spin, said spinning block comprising a pair of cables at respective sides for connection of a handle of an electric mobility scooter.
